(19) United States
(12) Patent Application Publication
(10) Pub. No.: US 2009/0303572 A1
(43) Pub. Date: Dec. 10, 2009

(54) SPECKLE REDUCTION IN IMAGING APPLICATIONS AND AN OPTICAL SYSTEM THEREOF

(75) Inventors: Regis Grasser, Mountain View, CA (US); Stojan Radic, San Diego, CA (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/134,566

(22) Filed: Jun. 6, 2008

(51) Int. Cl. G02B 26/08; H01S 3/10

(52) U.S. Cl. 359/298; 372/33

(57) ABSTRACT

Speckle effect in imaging applications is reduced by generating additional speckle patterns on the screen such that the speckle patterns are overlapped and the overlapped speckle patterns average out on the screen to appear as a noise background to the viewers. The speckle patterns are generated by discrete optical signals of a visible frequency comb. A visible frequency comb having discrete optical signals is generated through modulation-instability processes, phase-conjugation processes, and Bragg-scattering processes using a non-linear optical material and a wavelength converter.

### TECHNICAL FIELD OF THE DISCLOSURE

The technical field of this disclosure relates to the art of optical devices; and more particularly to the art of optical systems employing phase-coherent light and methods of using the same for reducing speckle effect in imaging applications.

### BACKGROUND OF THE DISCLOSURE

In recent years, solid-state light sources and other narrow-wavelength-band and/or polarized light sources capable of producing visible light have drawn significant attention as alternative light sources to traditional light sources for use in imaging systems (such as projection systems). This attention has been due to many advantages of these light sources, such as compact size, greater durability, longer operating life, higher efficiency, and lower power consumption. For example, solid state sources such as LASERs, light-emitting-diodes (LEDs), and pumped non-linear optical crystals are increasingly being used or considered for use in imaging systems, e.g. imaging systems that employ one or more light valves each of which comprises an array of individually addressable pixels due to their low Etendue or low divergence. Solid state light sources enable illumination systems and display systems to have reduced sizes and/or costs.

Regardless of certain superior properties over traditional light sources, solid-state light sources may produce unwanted artificial effects, one of which is speckle effect. Speckle effect arises when phase-coherent light, such as light from solid-state illuminators is scattered from a rough surface, such as a rough surface of a screen on which the images are displayed using the coherent light, and the scattered coherent light is detected by a detector having a finite aperture, such as the viewer's eyes. An image displayed on the screen appears to comprise quantized areas with sizes around the size of the detector's aperture. The intensities of the quantized areas in the displayed image often vary randomly, and such intensity variation (or fluctuation) is often referred to as the speckle effect.

In display applications using coherent light, such as light from solid-state illuminators, speckles accompanying the desired image displayed on a screen overlap with the desired image, and thus may significantly degrade the quality of the displayed image. Therefore, elimination or reduction of the speckle effect in display applications using phase-coherent light is highly desirable.

### SUMMARY

In one example, a speckle reduction method for use in a display system is disclosed herein. The method comprises: displaying an image on a screen using a first phase-coherent light beam, wherein the image comprises a first speckle pattern due to the speckle effect; and generating a second speckle pattern on the screen using a second phase-coherent light beam such that the second speckle pattern overlaps with the first speckle pattern on the screen.

In another example, a method of displaying an image is disclosed herein. The method comprises: producing a frequency comb having a set of discrete phase-coherent light lines; illuminating a spatial light modulator with the light lines of the frequency comb such that the light lines of the frequency comb is modulated by the spatial light modulator according to a set of image data derived from the image; and directing the modulated light from the spatial light modulator onto a screen.

In yet another example, a method of generating a visible frequency comb comprising a set of discrete visible laser lines is disclosed herein. The method comprises: generating a first laser line using a laser pump, a fiber Bragg lattice, and a first optical fiber; generating a visible laser line from the first laser line by using a frequency converter; generating a infrared frequency comb having a set of infrared laser lines from the first laser line and a seed laser line by using a second non-linear optical fiber; and converting the infrared frequency comb into the visible frequency comb by using the second non-linear optical fiber.

In yet another example, a device capable of producing a visible frequency comb having a set of visible laser lines is disclosed herein. The device comprises: a laser source for producing an infrared laser line; a wavelength converter for converting the infrared laser line into a visible laser line; a first non-linear optical fiber for generating an infrared frequency comb having a set of discrete infrared laser lines through a non-linear optical process; and a second non-linear optical fiber for converting the infrared frequency comb into the visible frequency comb.

In yet another example, a display system is provided herein. The system comprises: an illumination system for providing light, comprising: a laser source for producing an infrared laser line; a wavelength converter for converting the infrared laser line into a visible laser line; a first non-linear optical fiber for generating an infrared frequency comb having a set of discrete infrared laser lines through a non-linear optical process; and a second non-linear optical fiber for converting the infrared frequency comb into the visible frequency comb; a spatial light modulator comprising an array of individually addressable pixels for modulating the light from the illumination system; and a screen on which the modulated light is projected so as to form an image.

### BRIEF DESCRIPTION OF DRAWINGS

FIG. 1a through FIG. 1c schematically demonstrate a method of reducing speckle effect in display applications using phase-coherent light, wherein FIG. 1a schematically illustrates a speckle pattern on a screen due to the speckle effect; wherein FIG. 1b schematically illustrates multiple speckle patterns generated by phase-coherent light of different frequencies in a frequency comb; and wherein FIG. 1c schematically illustrates an overlapped speckle pattern by overlapping the speckle patterns illustrated in FIG. 1b such that the overlapped speckle pattern appears as a reduced speckle noise background to viewers.

FIG. 2a schematically illustrates an exemplary frequency comb comprising a sequence of substantially discrete optical lines for producing different speckle patterns illustrated in FIG. 1b, wherein each optical line graphically represents light of a finite characteristic frequency;

FIG. 2b schematically illustrates another exemplary frequency comb comprising a sequence of substantially discrete optical lines for producing different speckle patterns illustrated in FIG. 1b, wherein each optical line graphically represents light of a finite characteristic frequency;

FIG. 3a schematically illustrates the modulation instability in a non-linear optical process, which can be used for generating a frequency comb;

FIG. 3b schematically illustrates the phase-conjugate in the non-linear optical process as illustrated in FIG. 3a;

FIG. 3c schematically illustrates a Bragg scattering process that can be used for transferring a frequency comb in a non-visible light range into the visible light range;

FIG. 4 diagrammatically illustrates an exemplary structure for generating a frequency comb in the visible light range;

FIG. 5 diagrammatically illustrates exemplary dispersion curves of a non-linear optical fiber;

FIG. 6 and FIG. 7 schematically demonstrate an exemplary process for transforming a frequency comb in a non-visible light range into the visible light range; wherein FIG. 6 schematically illustrates the dispersion curve relative to the frequency comb to be transferred; and wherein FIG. 7 diagrammatically illustrates the parametric transformation process;

FIG. 8 diagrammatically illustrates an exemplary process for transforming a frequency comb in the infrared-light range into a frequency comb in the visible light range using a non-linear optical fiber having a zero-group velocity dispersion located between the two frequency combs;

FIG. 9 diagrammatically illustrates an exemplary optical structure capable of producing a frequency comb for using in speckle reduction in digital images;

FIG. 10a through FIG. 10c diagrammatically illustrate spectrums of light at different locations in the optical structure in FIG. 9;

FIG. 11 diagrammatically illustrates another exemplary optical structure capable of producing a frequency comb for using in speckle reduction in digital images;

FIG. 12a through FIG. 12d diagrammatically illustrate spectrums of light at different locations in the optical structure in FIG. 11; and

FIG. 13 diagrammatically illustrates an exemplary display system in which an optical structure capable of reducing speckle effect is implemented.

### DETAILED DESCRIPTION OF SELECTED EXAMPLES

Disclosed herein is a method of reducing speckle effect in display applications that employ phase-coherent light by using a frequency comb generated from the phase-coherent light. The phase-coherent light in the frequency comb causes separate speckle patterns on the screen. The separate speckle patterns overlap on the screen and average out as a noise background. Also disclosed is an optical structure capable of generating a frequency comb that comprises substantially discrete light lines of different frequencies by using a non-linear optical fiber. As will be detailed afterward, the optical structure can be used independently of the method of speckle reduction.

The speckle reduction method and the optical structure capable of reducing speckle effect will be discussed in the following, with particular examples where speckle patterns from speckle effect are caused by lasers. However, it will be appreciated by those skilled in the art that the following discussion is for demonstration purpose, and should not be interpreted as a limitation. Other variations within the scope of this disclosure are also applicable.

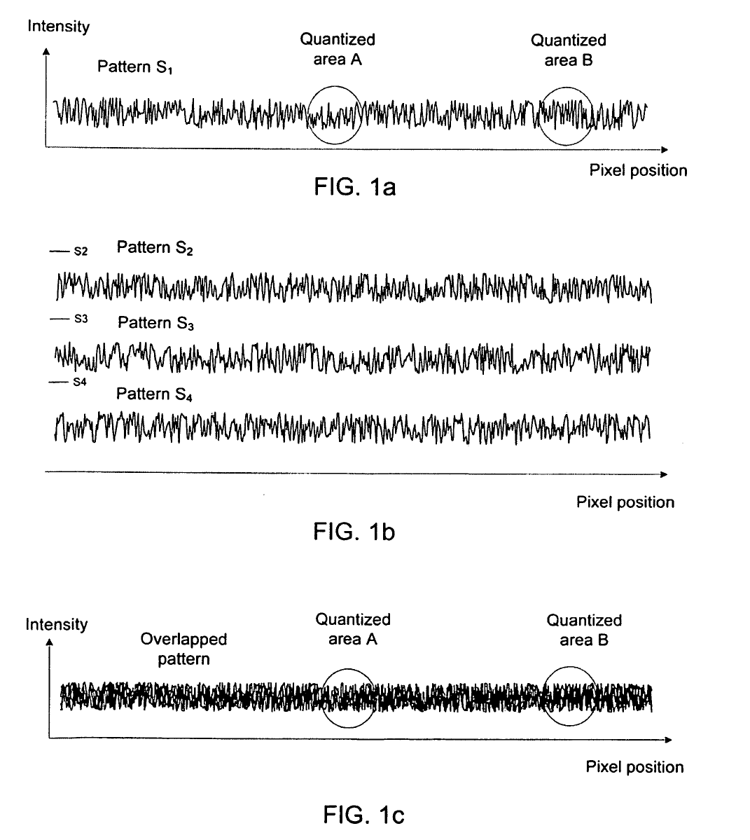

FIG. 1a through FIG. 1c schematically illustrates a method of reducing speckle effect in display applications that employ phase-coherent light. For demonstration purposes, FIG. 1a diagrammatically illustrates an exemplary speckle pattern S₁ along a row of image pixels on a screen from a laser beam of frequency ω₁ and speckle effect. The speckle pattern comprises speckles that appear to be quantized areas with randomly varying intensities to viewers. Speckles or quantized areas, such as quantized areas A and B, of different intensities in the speckle pattern can be perceived by viewers. The speckle effect can be reduced by generating multiple speckle patterns and overlapping the multiple speckle patterns on the screen such that the overlapped multiple speckle patterns are averaged out as a noise background, as schematically illustrated in FIG. 1b and FIG. 1c.

Referring to FIG. 1b, speckle pattern S₂ is generated on the screen using a laser beam with frequency ω₂ that is different from frequency ω₁ that generates speckle pattern S₁ as illustrated in FIG. 1a. If ω₁ and ω₂ are sufficiently spaced apart from each other, it can be assumed that the speckle patterns of ω₁ and ω₂ are fully decorrelated. The minimum frequency distance Δω between ω₁ and ω₂ to achieve decorrelation can be a complex function that includes parameters from the display optical engine such as the screen roughness. In typical examples, Δω can be 1 THz (˜1 nm wavelength) or higher or 5 THz (˜5 nm wavelength) or higher. If the desired degree of decorrelation is reached, speckle patterns S₁ and S₂ are substantially different. Specifically, the constructive interference and destructive interference locations of the speckle patterns S₁ and S₂ are randomly distributed across the speckle patterns S₁ and S₂. When the speckle patterns S₁ and S₂ are overlapped on the screen, the constructive and destructive interference in individual speckle patterns S₁ and S₂ are randomly distributed across the overlapped speckle pattern. As a consequence, the contrast ratio between the brightest area, corresponding to the area wherein the constructive interference occurs, and the darkest area, corresponding to the area wherein the destructive interference occurs, of the overlapped speckle patterns can be less than the contrast ratios of the individual speckle patterns. The speckles in the overlapped speckle patterns appear to be less perceivable by viewers. For example, the speckle (or noise) contrast can be reduced by a factor of √2 if both light beams of ω₁ and ω₂ carry the same optical energy.

In order to improve the speckle reduction, though not required, more speckle patterns, such as speckle patterns S₃ and S₄, can be generated and overlapped with speckle pattern S₁. As schematically illustrated in FIG. 1b, speckle patterns S₃ and S₄ are generated using laser beams with different frequencies ω₃ and ω₄, each of which can also be different from either one of frequencies of ω₁ and ω₂. Speckle patterns S₃ and S₄ can be overlapped with speckle patterns S₁ and S₂, as schematically illustrated in FIG. 1c.

Referring to FIG. 1c, the overlapped pattern comprises speckle patterns S₁, S₂, S₃ and S₄ that are generated by laser beams at frequencies of ω₁, ω₂, ω₃, and ω₄ In order to guarantee that the laser beams are substantially decorrelated, the minimum frequency difference between any pairs of laser beams is preferably 1 THz (˜1 nm wavelength) or higher or 5 THz (˜5 nm wavelength) or higher. The constructive and destructive interference in individual speckle patterns S₁, S₂, S₃ and S₄ are randomly distributed across the row of the image pixels, at which the overlapped speckle patterns is formed. As a consequence, individual speckle patterns are averaged out and appear as a noise background. The contrast ratio of the overlapped speckle patterns can be less than the contrast ratios of the individual speckle patterns. The observable quantized areas, such as quantized areas A and B in speckle pattern S₁ as illustrated in FIG. 1b, may not be observable by viewers. A way to evaluate the contrast reduction of these quantized areas is to calculate the square root of the number of laser beams involved with the assumption that the laser beams have substantially the same intensity.

As the number of speckle patterns generated by different frequencies increases, the contrast ratio of the overlapped speckle pattern can be reduced, and the perceived speckles or quantized areas can be reduced. However, the total number of different speckle patterns used for reducing the contrast of speckle patterns is preferably less than a threshold. This arises from the fact that the wavelength band available for each color in a display system allows for a certain number of laser beams of different frequencies due to the minimum frequency difference Δω. Moreover, increased number of speckle patterns may diminish the desired image displayed on the display target (e.g. screen). It is common to express the speckle visibility by the number of Modes M or the number of equivalent decorrelated laser beams reaching the screen with substantially the same energy (intensity). As the number of laser beams with different frequencies increases, the number of equivalent Modes M increases in a quasi-linear way. But the resulting contrast reduces by a factor of √M. Therefore, adding one extra Mode to 10 existing Modes in the system may reduce the speckle contrast by 1.5%. In contrast, adding one extra Mode to one existing Mode in the system may reduce the speckle contrast by 30%. In a typical example, 5 to 10 laser beams with different frequencies can be used for reducing contrast of speckle effect. Of course, any suitable number of laser beams with different frequencies can be employed in other examples.

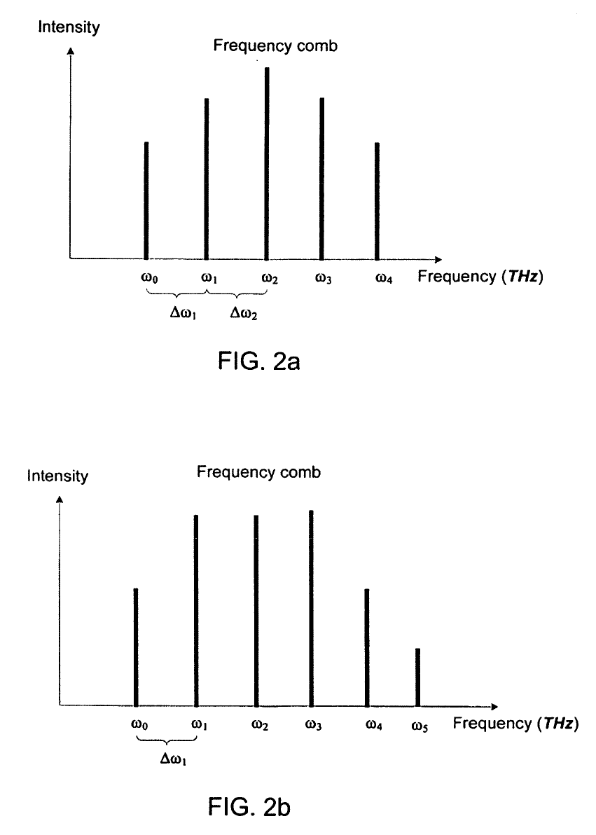

The speckle patterns are preferably generated by lasers beams or other phase-coherent light, of different frequencies. The laser beams each may have any suitable profiles, such as frequencies, intensities, and wavebands. However, it is preferred that the laser beams are substantially equally-spaced optical lines of a frequency comb, an example of which is schematically illustrated in FIG. 2a.

Referring to FIG. 2a, the frequency comb in this example comprises five laser lines with characteristic frequencies of ω₀, ω₁, ω₂, ω₃, and ω₄. It is noted that the frequency comb may comprise any suitable number of laser lines depending upon the specific application. Each laser line of the frequency comb may have any suitable intensity. In the example as illustrated in FIG. 2a, the frequency comb comprises a major laser line ω₂ at the center of the frequency comb. Lines ω₁ and ω₃ are located at the opposite sides of frequency ω₂, and have substantially the same intensity that is less than the intensity of the major line ω₂. Line ω₀ is at the lower frequency side of line ω₁; and line ω₄ is at the higher frequency side of line ω₃. Lines ω₀ and ω₄ have substantially the same intensity that is less than the intensity of lines ω₁ and ω₃.

The laser lines are substantially equally spaced. For example, the frequency difference Δω₁ between frequencies ω₀ and ω₁ is substantially equal to the frequency difference Δω₂ between frequencies ω₂ and ω₁. The frequency difference between adjacent lines can be of any suitable values depending upon the screen on which the images to be displayed. For example, the frequency difference between adjacent lines in the frequency comb can be from 1 THz to 50 THz and more preferably from 5 THz to 10 THz when the screen has a higher diffusion coefficient. In other words, the wavelength difference between adjacent laser-lines of the frequency comb is preferably 1 to 10 nm, and more preferably from 5 to 10 nm when the screen has a high diffusion coefficient. When the screen has as a lower diffusion coefficient, it is preferred that the frequency difference between adjacent lines of the frequency comb is 20 THz or higher and more preferably 50 THz or higher. In any instances, it is preferred that the frequency difference of adjacent lines guarantees that the laser lines are still in the desired wavelength range, such as the visible light range. It is noted that the frequency difference between adjacent lines in the frequency comb is preferably higher than a lower threshold such that the interference of adjacent laser lines in the frequency comb is minimized or avoided. Lasers with different profiles, such as the native bandwidths, may have different lower thresholds.

Another exemplary frequency comb that can be used for generating the speckle patterns as discussed above with reference to FIG. 1b and FIG. 1c is schematically illustrated in FIG. 2b. Referring to FIG. 2b, the frequency comb in this example comprises six laser lines with characteristic frequencies of ω₀, ω₁, ω₂, ω₃, ω₄, and ω₅. The frequency comb comprises three major laser lines ω₁, ω₂, and ω₃ with substantially the same intensity. Line ω₀ is at the lowest frequency end of the frequency comb; and line ω₅ is at the highest frequency end of the frequency comb. Line ω₄ is in the middle of frequencies ω₃ and ω₅. Lines ω₀ and ω₄ have substantially the same intensity that is less than the intensity of the major lines ω₁, ω₂, and ω₃. Line ω₅ has the least intensity.

The lines of the frequency comb can be generated in many ways. In one example, the lines can be derived from a single laser line, such as the major line of the frequency comb, through a non-linear optical process using a non-linear optical material, as will be discussed in the following.

A non-linear optical process can be described as a frequency-mixing process. If the induced dipolar moment D of a non-linear optical material responds instantaneously to an applied electric field E, the dipolar excitation D at time t can be written as a power series.

\vec{D}=ε₀(1+χ⁽¹⁾+χ⁽²⁾\vec{E}+χ⁽³⁾\vec{E}\vec{E}+ . . . )\vec{E} (Eq. 2)

The coefficient ε₀ is the electric permittivity of the free space. Coefficients χ⁽ⁿ⁾ are the n^{th} order susceptibilities of the non-linear optical material.

The third-order term in the equation above comes as χ⁽³⁾\vec{E}\vec{E}\vec{E}. Depending on the expression of the electric field \vec{E}, a non-linear process corresponding to the third term can have different names. The following discussion assumes that the electric field \vec{E} is the result of a combination of three distinct fields, as expressed in equation 3:

\vec{E}=\vec{ξ}₁e^{j(ω}^{₁}^{t-k}^{₁}^{z)}+\vec{ξ}₂e^{j(ω}^{₂}^{t-k}^{₂}^{z)}+\vec{ξ}₃e^{j(ω}^{₃}^{t-k}^{₃}^{z)}+c.c. (Eq. 3)

ξ₁, ξ₂, and ξ₃ are vector coefficients representing the directions of the E field components of the optical waves having frequencies of ω₁, ω₂, and ω₃. Given equation 3, the third-order term in equation 2 can be written as equation 4:

$$\begin{matrix}{χ}^{( 3 )} {E}^{->} {E}^{->} {E}^{->} = {\sum }_{ijk} {χ}_{ijk}^{( 3 )} {{ξ}^{->}}_{i} {{ξ}^{->}}_{j} {{ξ}^{->}}_{k} {e}^{j [ ( \pm {ω}_{i} \pm {ω}_{j} \pm {ω}_{k} ) t - ( \pm {k}_{i} \pm {k}_{j} \pm {k}_{k} ) z ]} + c . c . \\ = {\sum }_{l} {{ξ}^{->}}_{l} {e}^{j ( {ω}_{l} t - {k}_{l} z )} + c . c .\end{matrix} \qquad ( Eq . 4 )$$

When the three waves forming the electric field are made of three distinct fields at frequencies ωᵢ, ωⱼ and ωₖ and the resulting field ωₗ is also a distinct field, the non-linear process is referred to as a four-wave-mixing process.

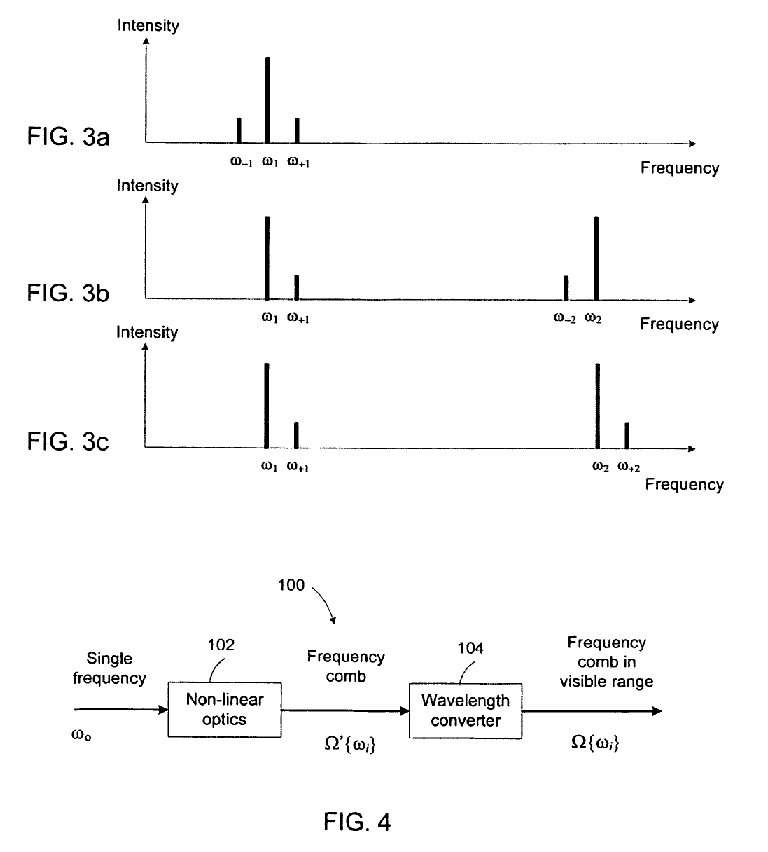

For demonstration purposes, FIG. 3a, FIG. 3b, and FIG. 3c diagrammatically illustrate four wave mixing processes of modulation-instability, phase-conjugation, and Bragg-scattering. Referring to FIG. 3a, two photons of frequencies ω₋₁ and ω₊₁ are generated from interaction of two incoming photons of frequencies ω₁, wherein ω₋₁ is equal to ω₁−Δω₁; and ω₊₁ is equal to ω₁+Δω₁. The resulted lines ω₋₁ and ω₊₁ have substantially the same amplitude that is less than the amplitude of the incoming two photons. This phenomenon is referred to as modulation instability, which can be summarized as equation 5. This modulation instability process is irreversible.

ω₋₁+ω₊₁=ω₁+ω₁ (Eq. 5)

FIG. 3b diagrammatically illustrates phase-conjugation process wherein two incoming photons of different frequencies ω₊₁ and ω₋₂ are generated from interaction of two incoming photos of different frequencies ω₁ and ω₂. ω₊₁ is equal to ω₁+Δω₁; and ω₋₂ is equal to ω₂−Δω₂. Δω₁ and Δω₂ have the same value. The generated frequencies ω₊₁ and ω₋₂ are located between frequencies ω₁ and ω₂. This phase-conjugation process can be summarized as equation 6. This phase-conjugate process is irreversible.

ω₋₂+ω₊₁=ω₁+ω₂ (Eq. 6)

Different from the phase-conjugation process, a Bragg-scattering process is referred to as a process wherein the frequencies of the incoming photons are located between the frequencies of the resulting photons, as schematically illustrated in FIG. 3c. Referring FIG. 3c, photons of frequencies ω₊₁ and ω₂ are generated from interaction of incoming photons with frequencies ω₊₂ and ω₁. ω₊₁ is equal to ω₁+Δω₁; and ω₊₂ is equal to ω₂+Δω₂. Δω₁ and Δω₂ have the same value. Frequencies ω₊₁ and ω₊₂ are between frequencies ω₊₂ and ω₁. This Bragg-scattering process is reversible. In another word, photons with frequencies ω₊₁ and ω₂ can result from interaction of incoming photos with frequencies ω₊₂ and ω₁.

During a non-linear optical process where energy is transferred from an optical signal of one frequency to another, energy and phase are conserved. In an example for a four-wave-mixing process, the energy conservation can be expressed as equation 7.

ωₗ=±ωᵢ±ωⱼ±ωₖ (Eq. 6)

ωᵢ, ωⱼ, and ωₖ are frequencies of the three incoming optical signals, and ωₗ is the frequency of the resulted fourth optical signal. The phase-conservation can be expressed with wave-vectors k as equation 7.

kₗ=±kᵢ±kⱼ±kₖ (Eq. 7)

Given equation 7, the wave-vector of a laser beam traveling within an optical fiber, for example, can be written as equation 8.

$$k = {β}_{o} ( {ω}_{o} ) + {β}_{1} ( {ω}_{o} ) ( ω - {ω}_{o} ) + \frac{1}{2} {β}_{2} ( {ω}_{o} ) {( ω - {ω}_{o} )}^{2} + \frac{1}{4} {β}_{3} ( {ω}_{o} ) {( ω - {ω}_{o} )}^{3} + … \qquad ( Eq . 8 )$$

Coefficients βₙ define the dispersion curve of the optical fiber. The dispersion curve is important especially for converting non-visible light into visible light, which will be discussed afterwards.

By using a non-linear optical material and non-linear optical processes, a frequency comb having optical lines with suitable frequencies can be obtained. An exemplary process for obtaining a suitable frequency comb from a single incoming optical wave is diagrammatically illustrated in FIG. 4.

Referring to FIG. 4, incoming optical signal (e.g. a laser beam) of a characteristic frequency ωₒ is passed to non-linear optics 102 of optical system 100. The non-linear optics can be a non-linear optical material, such as a non-linear optical fiber. The incoming optical signal ωₒ experiences a non-linear optical process, referred to as modulation instability within the non-linear optics (102) and results in a frequency comb Ω′{ωᵢ}. The frequency comb comprises a set of optical signals with different frequencies ωᵢ. The non-linear optics (102) can be any suitable optics. In one example, the non-linear optics can be a non-linear optical fiber, such as optical fibers doped with rare-earth elements, which can be erbium, ytterbium, neodymium, dysprosium, praseodymium, thulium, and other suitable elements. In addition to non-linear optical fibers, the non-linear optics (102) can be other optical elements possessing non-linear optical properties.

As will be seen in the following, the modulation instability process occurs under specific conditions in term of dispersion. Often however, those conditions are satisfied in the infra-red region. The generated optical signals in the frequency comb may therefore not be visible light. This problem can be solved by transferring the generated infra-red comb into the visible regime by using other four waves mixing processes, such as Bragg scattering or phase conjugation. This is possible if a visible light beam is already available. A wavelength converter (104) can be used for converting optical signals in one light range into optical signals in another light range, such as from the infrared-light range to the visible-light range. After the conversion and the additional four wave mixing process, a frequency comb Ω{ωᵢ} within the desired light range can be obtained. The wavelength converter (104) can be any suitable optics. In one example, the wavelength converter (104) can be a non-linear crystal disposed within a resonance cavity. The non-linear crystal can be a frequency-doubling crystal, such as crystals of lithium niobate (LiNbO₃) and lithium tantalite (LiTaO₃). Other suitable optics are also applicable.

The frequency comb generation process as illustrated in FIG. 4 can be implemented in many ways. For demonstration purposes, an exemplary process will be discussed in the following wherein a frequency comb in the visible light range is generated from a four-wave-mixing process by using non-linear optical fibers and a frequency-doubling crystal. It will be appreciated by those skilled in the art that the following discussion is for demonstration purpose and should not be interpreted as a limitation. Other variations are also applicable.

As discussed above with reference to FIG. 3a, a modulation instability process can generate multiple optical lines of different frequencies out of a single optical line—that is, two photons at ω₁ can generate one photon at to ω₊₁ and another photon at ω₋₁. This modulation instability process can be used to generate multiple optical lines from a single optical line.

This modulation instability process is dependent from the behavior of the fiber group velocity ν_{g} that is equal to 1/β₁, wherein β₁ is the group velocity dispersion of the optical fiber. Specifically, positive gains during the modulation instability process can be obtained if the group velocity dispersion β₂ is negative, or if the dispersion D is positive, as expressed in equation 9.

$$\begin{matrix}{β}_{2} = \frac{\partial ( 1 / {v}_{g} )}{\partial ω} < 0 , or \\ D = \frac{\partial ( 1 / {v}_{g} )}{\partial λ} > 0\end{matrix} \qquad ( Eq . 9 )$$

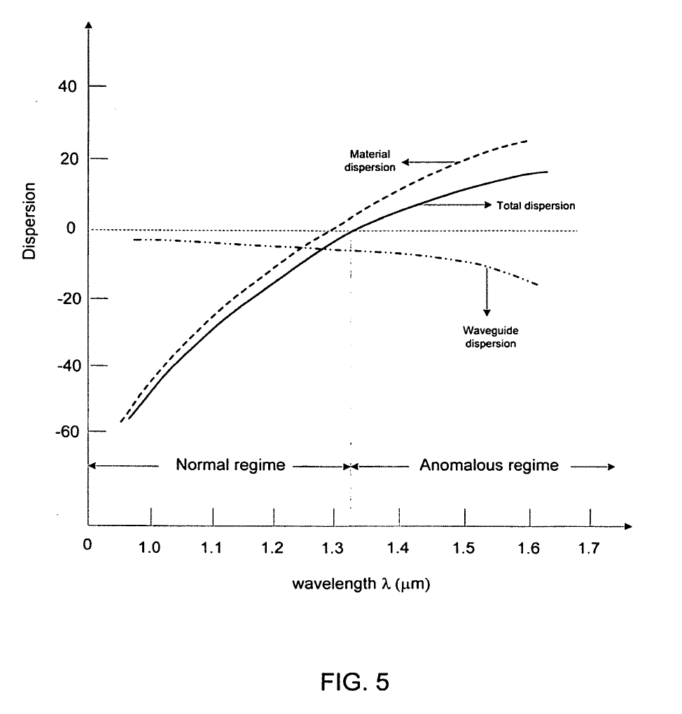

The condition in equation 9 is often satisfied in the anomalous dispersion regime of non-linear optical fibers. For demonstration purpose, FIG. 5 diagrammatically illustrates a dispersion curve of a typical non-linear optical fiber, such as ytterbium-doped optical fibers. Referring to FIG. 5, the total dispersion of an optical fiber often comprises material dispersion and waveguide dispersion. Material dispersion comes from a frequency-dependent response of a material to waves; and waveguide dispersion occurs when the speed of a wave in a waveguide (such as an optical fiber) depends on its frequency for geometric reasons, independent of any frequency dependence of the materials from which it is constructed. More generally, “waveguide” dispersion can occur for waves propagating through any inhomogeneous structure, whether or not the waves are confined to some region.

As illustrated in FIG. 5, the normal regime of the total dispersion curve is the regime wherein the total dispersion is negative. The anomalous regime is the regime wherein the total dispersion is zero or positive. The gain obtained in the anomalous regime can be maximized when the frequency difference Δω satisfies equation 10, wherein frequency difference Δω is between the resulted optical line and the incoming optical line. For example, Δω can be the frequency difference between ω₁ and ω₋₁ or between ω₁ and ω₊₁ in FIG. 3a.

$$Δω = \pm \sqrt{\frac{4 γ P}{\vert {β}_{2} \vert}} \qquad ( Eq . 10 )$$

Coefficient γ, P and β₂ correspond respectively to the non-linear coefficient of the optical fiber in the unit of W⁻¹.km⁻¹, the infrared light intensity (power) in the unit of W, and the group velocity dispersion in the unit of ps².km⁻¹. By adjusting the above coefficients of γ, P and β₂, the desired frequency difference Δωᵢ between adjacent optical lines in a frequency comb, such as the frequency difference Δω₁ (e.g. from 1 to 100 THz) as discussed above with reference to FIG. 2a and FIG. 2b can be obtained.

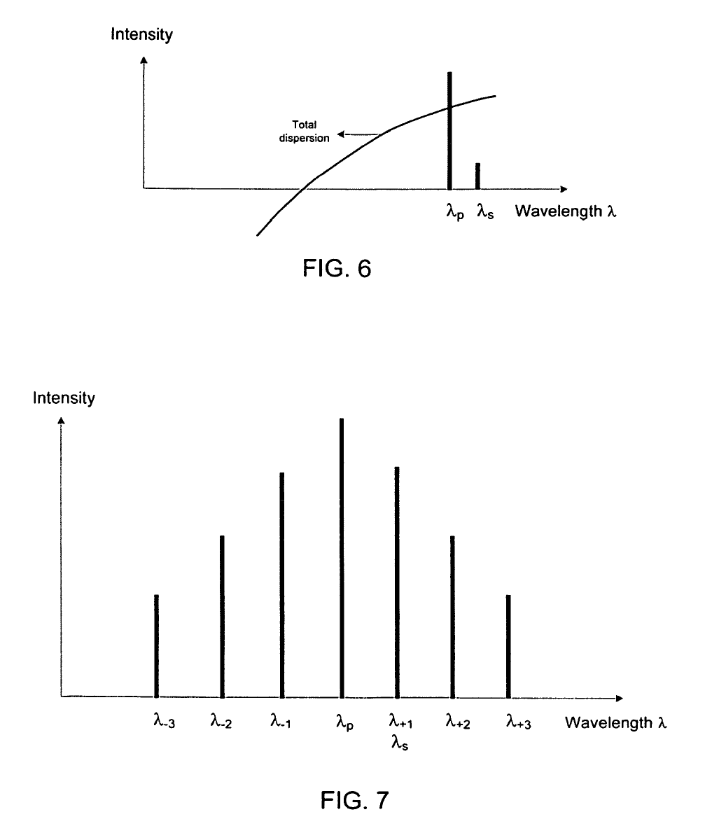

When a single optical line (e.g. a single laser signal) is passed through a non-linear optical fiber, the modulation instability process may broaden or spread the spectrum of the signal optical line, instead of generating a set of discrete optical lines of a frequency comb that can be used for speckle reduction as discussed above with reference to FIG. 1a through FIG. 1c. In order to generate a frequency comb with discrete optical lines, a seed line signal with a suitable frequency can be used along with the signal optical line to initiate the modulation instability process, as schematically illustrated in FIG. 6.

Referring to FIG. 6, optical line with wavelength λₚ is the principal optical line to be passed through a non-linear material, such as a non-linear optical fiber for generating a frequency comb. This principal optical signal may be provided by a fiber laser at typically 1060 nm, itself generated by a pump at typically 980 nm. The optical line with wavelength λₛ is a seed optical line. The wavelength difference between λₚ and λₛ is determined by the desired frequency difference between adjacent optical lines in the frequency comb to be generated, such as the frequency difference Δω₁ (e.g. from 1 to 100 THz) as discussed above with reference to FIG. 2a and FIG. 2b.

In general, the seed frequency may have any suitable intensity. In the example as illustrated in FIG. 6, the seed line is a weak laser signal having an intensity that is 50% or less, 20% or less, 10% or less, 5% or less of the intensity of the principal optical line at wavelength λₚ. Alternatively the pump and seed signals can be generated by the same laser or fiber laser. In case of a fiber laser, the system can be adjusted to deliver two pumps of substantially equal energy separated by the targeted Δω. When the principal and the seed optical lines λₚ and λₛ are located at the anomalous regime of the dispersion curve of the non-linear optical material (e.g. non-linear optical fiber) as illustrated in FIG. 6, the principal and the seed optical lines may generate a set of discrete optical lines of a frequency comb through a cascaded modulation-instability process with proper gains. For demonstration purpose, FIG. 7 diagrammatically illustrates the parametric modulation-instability processes.

Referring to FIG. 7, the incoming optical lines λₚ and λₛ experience modulation-instability processes, Bragg scattering processes, and phase-conjugation processes, each of which can be cascaded processes in this example, in the non-linear optical material (e.g. a non-linear optical fiber), which can be expressed in equation 11.

λₚ+λₚ→λ₊₁+λ₋₁

λₚ+λ₊₁(λₛ)→λ₋₁+λ₊₂

λ₊₁+λ₊₂→λₚ+λ₊₃

λₚ+λ₋₁→λ₋₂+λ₊₁

λ₋₁+λ₋₂→λₚ+λ₋₃ (Eq. 11)

It is noted that the resulted optical line at wavelength λ₊₁ is at substantially the same wavelength location of λₛ. The above cascaded processes continue until all optical lines are balanced—that is, all optical lines reach at an equilibrium state. In practice, more optical lines may be generated. For example, optical lines with wavelengths less than λ₋₃ or higher than λ₊₃ may be obtained. Because intensities of those optical lines are far less than the optical lines having wavelengths between λ₋₃ or higher than λ₊₃, those optical lines may be ignored.

When the seed optical line is a weak line, the generated frequency comb has a single peak line at λₚ as illustrated in FIG. 7. When the seed optical line has intensity comparable to the intensity of the principal optical line λₚ, the resulted frequency comb may have two parallel peak lines at wavelengths λₚ and λ₊₁ (λₛ). The resulted lines in the frequency comb are substantially uniformly spaced such that the wavelength difference between adjacent line lines corresponds to the desired frequency difference Δω₁ (e.g. from 1 to 100 THz) as discussed above with reference to FIG. 2a and FIG. 2b. By selecting different intensities of the principal and the seed lines, suitable total number of lines in the frequency comb can be obtained.

The generated frequency comb, however, may not be in the desired wavelength range. For example, the generated frequency comb may be in the infrared-light range instead of visible light range. This arises from the fact that, even though non-linear optical fibers can be engineered to produce any type of dispersion curves, the anomalous regime of the non-linear optical fiber is often in the higher wavelength range (e.g. the infrared-light range). It is practically very difficult to modify the optical fiber properties so as to have an anomalous regime in the visible-light range. This problem can be solved through a wavelength conversion process by using a wavelength conversion module (e.g. wavelength converter 104 in FIG. 4) and some additional non-linear processes.

In a standard frequency doubling process, for example, in exiting fiber lasers, the generated visible light from an infrared light using a frequency doubling crystal, however, has very limited bandwidth, such as a bandwidth less than 1 THz. Moreover, this frequency doubling process is mostly workable for a single optical line, such as a frequency comb having a single laser line. In order to convert discrete optical lines of a frequency comb from the infrared-light range to the visible light range for speckle reduction, phase-conjugation and Bragg-scattering processes as discussed above with reference to FIG. 3b and FIG. 3c can be employed.

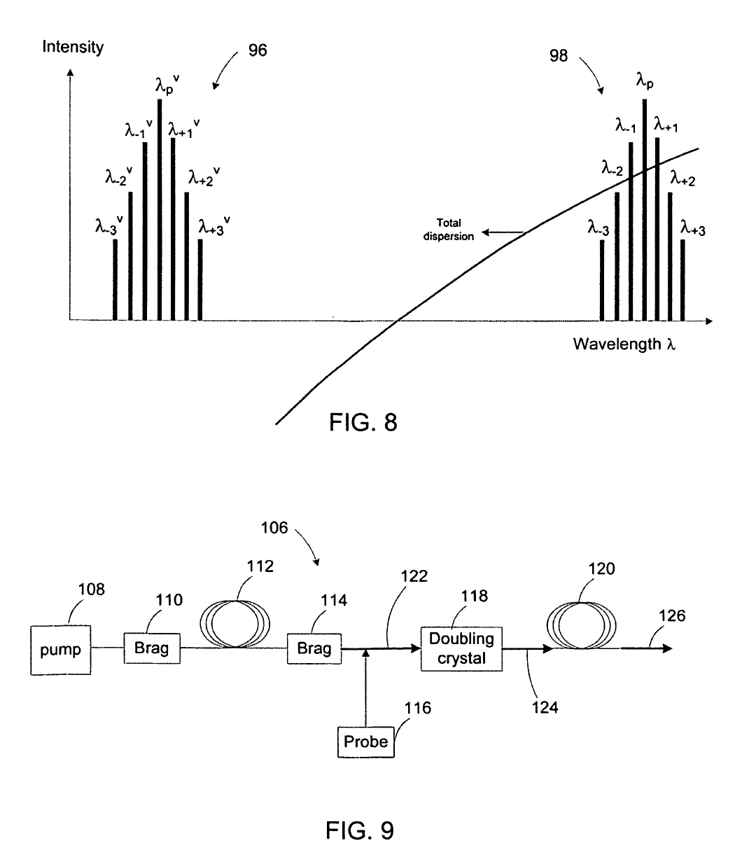

As discussed above with reference to FIG. 3a and FIG. 3b, using a phase-conjugation process or a Bragg-scattering process to convert an infrared-light line into a visible light line needs an existing visible light line as an incoming light line. Therefore, it is expected to generate a visible light line and use the generated visible light line for converting the frequency comb from the infrared light range to the visible light range. In order to improve the efficiency of the conversion of a frequency comb from the infrared-light range to the visible light range, it is preferred that the phase-conservation during the conversion is maintained. The phase-conservation can be marinated when the group velocity dispersion β₂ is equal to zero between the infrared light lines and the visible light lines, as diagrammatically illustrated in FIG. 8. The point wherein β₂=0 is referred to as the zero-dispersion wavelength (ZDW). The zero-dispersion-wavelength can be obtained through appropriate engineering of the selected non-linear optical material (e.g. a non-linear optical fiber) such that the ZDW is at the desired place.

Referring to FIG. 8, optical lines with wavelengths between λ₋₃ and λ₊₃ are infrared light of a frequency comb 98. Light line with wavelength λₚ^{ν} is a visible light line generated from infrared light line λₚ through a frequency-doubling process, for example, using a frequency doubling crystal. Visible light lines λ₊₁^{ν}, λ₊₂^{ν}, λ₊₃^{ν}, λ₋₁^{ν}, λ₋₂^{ν}, and λ₋₃^{ν} can then be generated from visible light line λₚ^{ν} and infrared-light line λₚ, λ₊₁, λ₊₂, λ₊₃, λ₋₁, λ₋₂, and λ₋₃ given that the total dispersion curve has a zero-dispersion wavelength point located between the infrared-light range and the visible light range, specifically, substantially in the middle between visible light line λₚ^{ν} and infrared light line λₚ.

As can be seen from the above discussion, both of the process for generating additional light lines (e.g. through a modulation instability process) and the process for converting the generated frequency comb from one light range (e.g. the infrared-light range) to another (e.g. the visible light range) can be performed by using the same non-linear optical material, such as a non-linear optical fiber. This fact may significantly reduce the cost of optical systems for speckle reduction or other purposes.

For demonstration purposes, FIG. 9 diagrammatically illustrates an exemplary optical system capable of producing a frequency comb having visible light lines. The frequency comb in the visible light range can be used for speckle reducing in compliance with the method as discussed above with reference FIG. 1a through FIG. 1c.

Referring to FIG. 9, optical system 106 in this example comprises light pump 108, Bragg lattices 110 and 114, non-linear optical fiber 112 between Bragg lattices 110 and 114, probe 116, doubling crystal 118, and non-linear optical fiber 120.

Light pump 108 is provided for generating pump laser lines, which can be a continuous wave laser or a diode laser or diode laser array. For example, a continuous wave laser can be a Ti:Al₂O₃ laser operated in 980 nm absorption waveband. A diode laser array can be an indium-gallium-arsenide diode array laser operated in the 980 nm waveband. Other suitable laser pumps are also applicable.

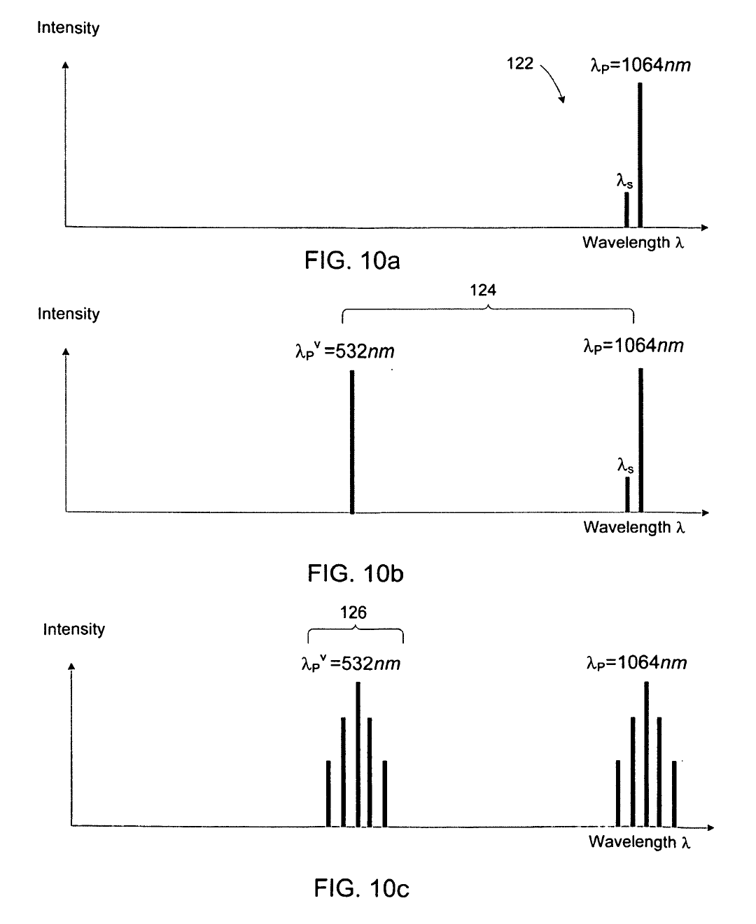

The pump laser line from pump 108 is delivered to a resonator that comprises Bragg lattices 110 and 114 with non-linear optical fiber 112 disposed therebetween. The non-linear optical fiber (112) in this example is an ytterbium-doped double-clad fiber. The non-linear optical fiber (112) can be other suitable optical fibers, such as an optical fiber doped with rare-earth elements, which can be erbium, neodymium, dysprosium, praseodymium, thulium, and other suitable elements. After the resonator, a suitable laser line (122), such as a laser line of 1064 nm can be obtained. As discussed above, a seed laser line can be employed for generating discrete laser lines of a frequency comb. The seed laser line can be obtained by injecting a seed laser line from probe 116 or the pump (or other separate pumps). It is noted that the seed signal can alternatively be injected at any suitable stages before the non-linear optical fiber, such as being injected after the frequency doubling. The obtained laser lines (122) are diagrammatically illustrated in FIG. 10a.

Referring to FIG. 10a, the line laser line has a wavelength λₚ equal to 1064 nm. The seed laser line with a wavelength λₛ such that the wavelength difference between λₚ and λₛ corresponds to the desired frequency difference Δω₁ (e.g. from 1 to 100 THz) as discussed above with reference to FIG. 2a and FIG. 2b.

Referring back to FIG. 9, the obtained laser line 122 is passed through frequency-doubling crystal 118 that generates a visible laser line from the input pump laser line 122, as diagrammatically illustrated in FIG. 10b.

Referring to FIG. 10b, light spectrum 124 is the output from the frequency-doubling crystal (118). Visible light line λₚ^{ν} equal to 532 nm is generated from the pump laser line λₚ of 1064 nm. The generated visible laser line (532 nm) and the infrared pump-laser line (1064 nm) of light 124 is passed through non-linear optical fiber 120, as illustrated in FIG. 9. The non-linear optical fiber (120) can be the same as non-linear optical fiber 112, which will not be repeated herein. Within non-linear optical fiber 120, the visible laser line (532 nm) and the infrared pump-laser line (1064 nm) of light 124 experience cascaded modulation instability processes, through which, discrete laser lines in the infrared light range are generated, as diagrammatically illustrated in FIG. 10c. Specifically, with reference to FIG. 10c, a infrared frequency comb having discrete infrared laser lines centered at λₚ of 1064 nm can be generated through the cascaded modulation-instability processes within the non-linear optical fiber 120 (as shown in FIG. 9). Within the same non-linear optical fiber 120, the infrared frequency comb is converted to a visible frequency comb having visible laser lines centered at λₚ^{ν} equal to 532 nm through phase-conjugation and Bragg-scattering processes, as also illustrated in FIG. 10c. The generated visible frequency comb 126 can then be used for speckle reduction through a speckle reduction process as discussed above with reference to FIG. 1a through FIG. 1c, which will not be repeated herein.

Another exemplary optical system capable of generating a visible frequency comb having discrete laser lines is diagrammatically illustrated in FIG. 1. Referring to FIG. 1, light pump 108, Bragg lattices 110 and 114, non-linear optical fiber 112, probe 116, frequency-doubling crystal 118, and non-linear optical fiber 120 can be the same as those corresponding members in the optical system in FIG. 9 and are arranged in the same way as those corresponding members in the optical system in FIG. 9.

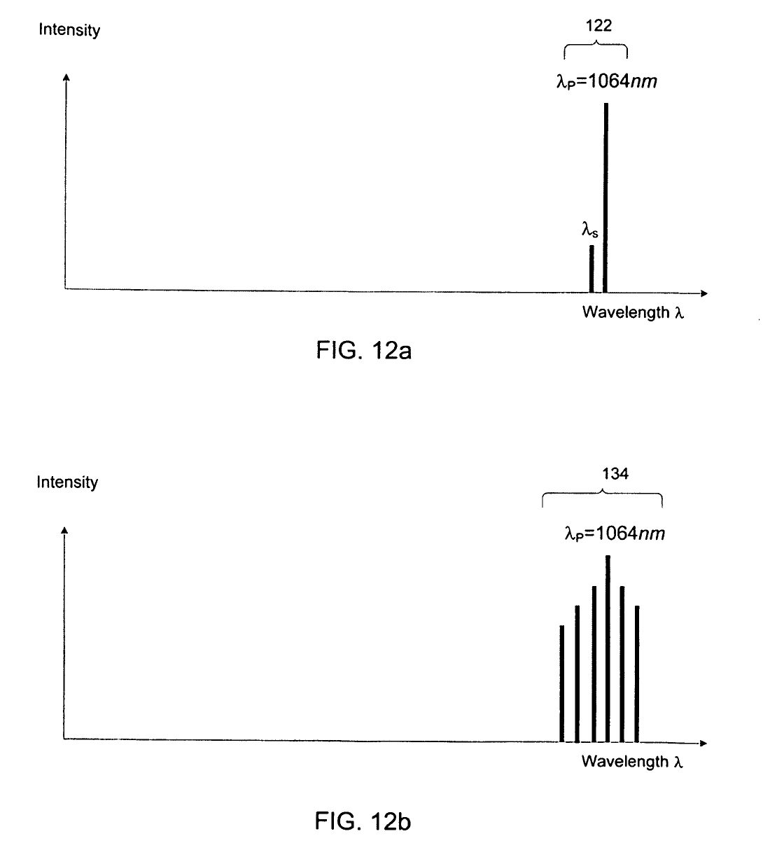

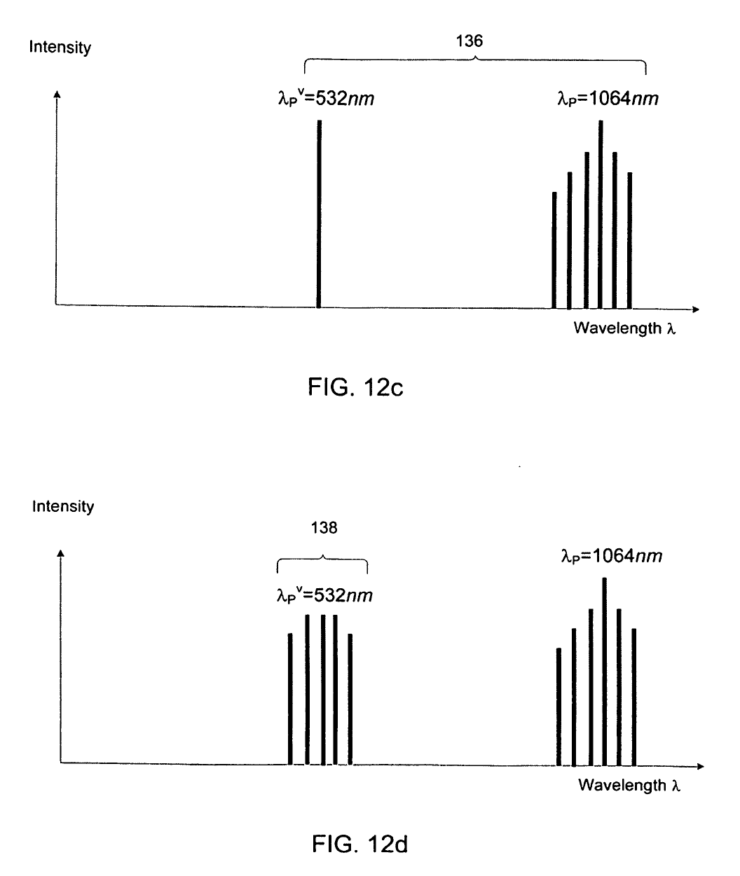

The light 122 generated after the resonator (comprising Bragg lattices 110 and 114 and nonlinear optical fiber 112) and probe 116 is diagrammatically illustrated in FIG. 12a, which can be the same as that discussed above with reference to FIG. 10a. Light 122 with laser line λₚ of 1064 nm and seed laser line λₛ is passed through non-linear optical fiber 120. The non-linear optical fiber 120 generates light 134 of an infrared frequency comb 134 from the incident light 122 through cascaded modulation-instability processes. The generated infrared frequency comb 134 is diagrammatically illustrated in FIG. 12b. As can be seen in FIG. 12b, the frequency comb comprises discrete laser lines with the principal line having a wavelength of 1064 nm. The discrete laser lines are substantially equally spaced such that the wavelength difference between adjacent laser lines corresponds to the desired frequency difference Δω₁ (e.g. from 1 to 100 THz) as discussed above with reference to FIG. 2a and FIG. 2b.

In order to efficiently convert the infrared laser lines in the infrared range to a frequency comb in the visible light range through phase-conjugation and Bragg-scattering processes as discussed above, light 134 after non-linear optical fiber 120 is passed through frequency-doubling crystal 118 so as to generate a visible light line. The spectrum of the generated light 136 after the frequency-doubling crystal is diagrammatically illustrated in FIG. 12c. As can be seen in FIG. 12c, a visible laser line with a wavelength λₚ^{ν} of 532 nm is generated. Light 136 after the frequency-doubling crystal (118) is passed through another non-linear optical fiber 132. Within the non-linear optical fiber 132, the incident light of infrared frequency comb is converted to visible light 138, as diagrammatically illustrated in FIG. 12d, through phase-conjugation and Bragg-scattering processes.

As can be seen in FIG. 12d, the frequency comb in the infrared light range having laser lines peaked at 1064 nm is converted to frequency comb 138 having laser lines in the visible light range. The peak visible laser lines are centered at wavelength 532 nm. The generated visible frequency comb 136 can then be used for speckle reduction through a speckle reduction process as discussed above with reference to FIG. 1a through FIG. 1c, which will not be repeated herein.

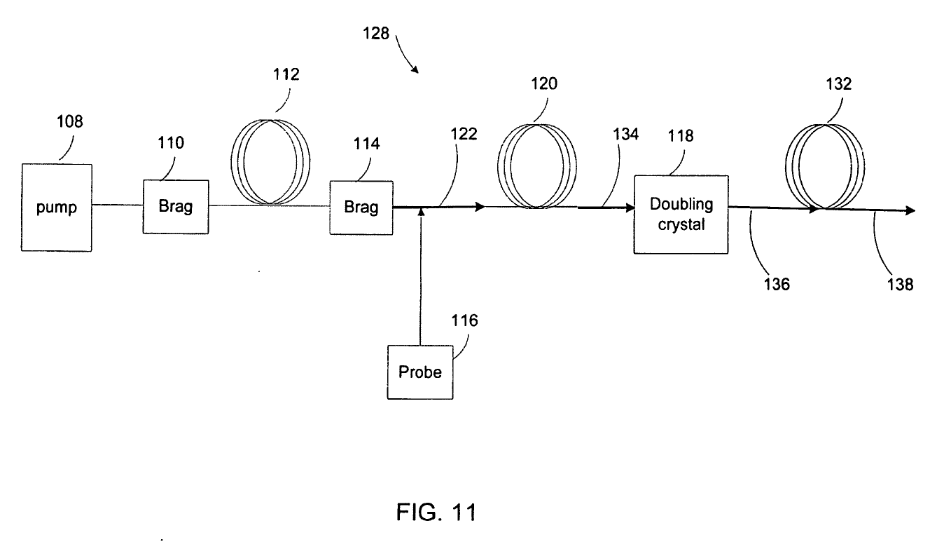

It is noted that the visible frequency comb generated by the optical systems as discussed above with reference to FIG. 9 and FIG. 11 can be used for other purposes than speckle reduction in imaging applications. For example in display applications using lasers, it is often preferred that the illumination laser light has a specific bandwidth, which is often broader than the laser light from a single laser source. In these instances, a frequency comb having a set of laser lines can be employed.

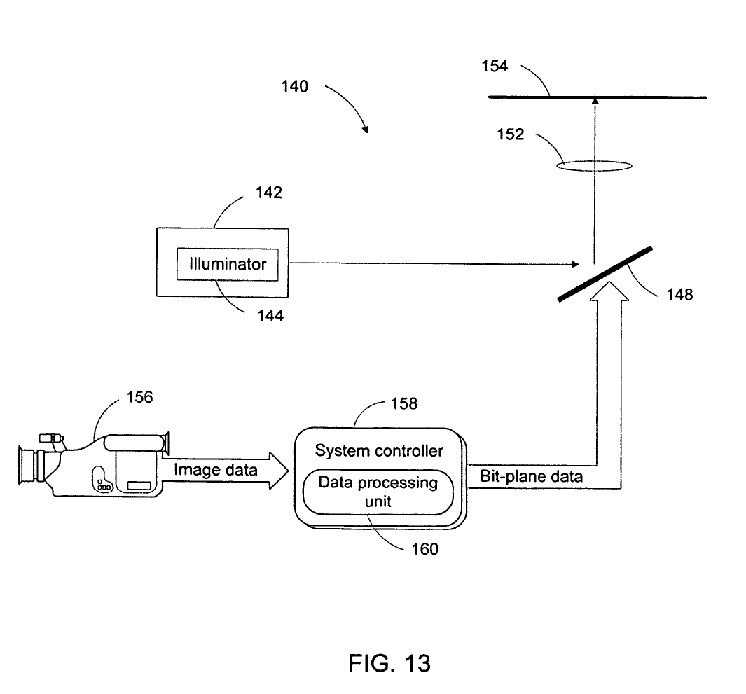

As an example, FIG. 13 diagrammatically illustrates an exemplary display system in which an optical structure capable of speckle reduction is implemented therein. Referring to FIG. 13, a display system comprises illumination system 142 that further comprises illuminator 144. The illuminator (144) may comprise an optical system as discussed above with reference to FIG. 4, FIG. 11, or FIG. 9 for generating a desired frequency comb in the visible-light range. The laser light of the frequency comb from illuminator 144 is directed to spatial light modulator 148 that modulates the incident laser light and directs the modulated laser light onto or away from projection lens 152. The projection lens (152) projects the modulated light onto screen 154 so as to generate the desired images. The modulation operation of spatial light modulator 148 is based on image data, such as bitplane data from data processing unit 160 of system controller 158. The system controller (158) is connected to multimedia source 156, such as a video and/or an image source, which provides multimedia signals. It is noted that the multimedia source may or may not be a member of the display system. When the multimedia source is not included within the imaging system, the imaging system may have an interface (e.g. HDMI, DVI, s-video, audio, and many other interfaces) for receiving signals from external multimedia sources.

The screen (154) can be a screen on a wall or the like, or can be a member of a rear projection system, such as a rear projection television. In fact, the display system can be any suitable display system, such as a front projector, a rear projection television, or a display unit for use in other systems, such as mobile telephones, personal data assistants (PDAs), hand-held or portable computers, camcorders, video game consoles, and other image displaying devices, such as electronic billboards and aesthetic structures.

Spatial light modulator 148 comprises an array of individually addressable pixels for spatially modulating the incident light. The spatial light modulator may comprise pixels of many different types, such as reflective and deflectable micromirrors or liquid-crystal-on-silicon (LCOS) pixels. The pixels can be operated in binary or non-binary mode. In binary mode, each pixel is switched between an ON and OFF state. At the ON state, each pixel modulates the incident light onto the projection lens (152). At the OFF state, each pixel modulates the incident light away from the projection lens. The pixels of the spatial light modulator alternatively can be operated in a non-binary mode, such as in an analog mode where multiple intermediate states are defined between an ON and OFF state; and the intermediate states may or may not be continuous between the ON and OFF states. In either binary or non-binary operation mode, color and gray images can be produced using a line-width-modulation technique.

It will be appreciated by those of skill in the art that a new and useful method for speckle reduction and an optical system capable of speckle reduction have been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

I claim:

1. A speckle reduction method for use in a display system, comprising:
displaying an image on a display target using a first phase-coherent light beam, wherein the image comprises a first speckle pattern due to a speckle effect; and
generating a second speckle pattern on the display target using a second phase-coherent light beam such that the second speckle pattern overlaps with the first speckle pattern on the display target.

2. The method of claim 1, wherein the first and second phase-coherent light beams propagates along substantially the same optical path in the display system.

3. The method of claim 1, the first or the second phase-coherent light beam is laser light.

4. The method of claim 1, the first and second phase-coherent light beams are light lines of a visible frequency comb that comprises a set of light lines, and wherein the frequency difference between adjacent light lines in the frequency comb is from 1 THz. to 50 THz.

5. The method of claim 1, wherein the step of generating a second speckle pattern further comprises:
generating a visible frequency comb having a set of visible laser lines; and
displaying the image by using the visible laser lines of the frequency comb.

6. The method of claim 5, wherein the step of generating a visible frequency comb further comprises:
generating a first laser beam;
passing the first laser beam through a non-linear optics, within which a second laser beam having a frequency different laser beam is generated from the first laser beam; and
converting the second laser beam into the visible light range.

7. The method of claim 6, further comprising:
passing a seed laser beam along with the first laser signal through the non-linear optics that is a frequency-doubling crystal so as to generate a visible laser line; and
passing a light beam output from the frequency-doubling crystal through another non-linear optical fiber so as to convert the laser lines from outside the visible light range into the visible light range.

8. The method of claim 5, wherein the step of generating a visible frequency comb further comprises:
generating a first laser beam and a seed laser beam;
passing the first and the seed laser beams through a first non-linear optical fiber so as to generate a first frequency comb having a set of laser lines in the infrared light range;
passing the laser lines of the first frequency comb through a wavelength converter so as to generate a visible laser line from the first frequency comb; and
passing the generated visible laser line and the laser lines of the first frequency comb through a second non-linear optical fiber so as to convert the first frequency comb into a second frequency comb having a set of laser lines in the visible light range.

9. A method of displaying an image, comprising:
producing a set of discrete phase-coherent light lines that are laser light beams;
illuminating a spatial light modulator with the light lines such that the light lines are modulated by the spatial light modulator; and
directing the modulated light from the spatial light modulator onto a display target.

10. The method of claim 9, wherein the frequency difference between adjacent laser lines in the set of discrete phase-coherent light lines is from 1 THz to 50 THz.

11. The method of claim 10, wherein the set of discrete phase-coherent light lines is produced from a laser line using first and second non-linear optical fibers of substantially the same optical property.

12. The method of claim 9, wherein the step of producing a set of discrete phase-coherent light lines comprises:
generating a first laser beam and a seed laser beam;
passing the first and the seed laser beams through a first non-linear optical fiber so as to generate a first set of discrete phase-coherent laser lines in an infrared light range;
passing the laser lines of the first set of discrete phase-coherent laser lines through a wavelength converter so as to generate a visible laser line from the first set of laser lines; and
passing the generated visible laser line and the laser lines of the first set of discrete phase-coherent laser lines through a second non-linear optical fiber so as to convert the infrared laser lines in the first set of discrete phase-coherent laser lines into a second set of discrete phase-coherent laser lines in a visible light range.

13. The method of claim 9, wherein the step of producing a set of discrete phase-coherent light lines comprises:
generating a first laser beam and a seed laser beam;
passing the first and the seed laser beams through a wavelength converter so as to generate a visible laser beam from the first laser beam; and
passing the visible laser beam, the first laser beam, and the seed laser beam through a non-linear optical fiber so as to generate a second set of discrete phase-coherent laser lines in a visible light range.

14. A method of generating a visible frequency comb comprising a set of discrete visible laser lines, the method comprising:
generating a first laser line using a laser pump, a fiber Bragg lattice, and a first optical fiber;
generating a visible laser line from the first laser line by using a frequency converter;
generating a infrared frequency comb having a set of infrared laser lines from the first laser line and a seed laser line by using a second non-linear optical fiber; and
converting the infrared frequency comb into the visible frequency comb by using the second non-linear optical fiber.

15. The method of claim 14, wherein the first and the second non-linear optical fibers have substantially the same optical property.

16. The method of claim 14, wherein the second non-linear optical fiber has a zero-dispersion wavelength point that is substantially in the middle of the infrared frequency comb and the visible frequency comb.

17. The method of claim 14, wherein the step of generating an infrared frequency comb is performed prior to the step of generating a visible laser line.

18. The method of claim 14, wherein the frequency difference between adjacent laser lines in the frequency comb is from 1 THz to 50 THz.

19. A device capable of producing a visible frequency comb having a set of visible laser lines, comprising:
a laser source for producing an infrared laser line;
a wavelength converter for converting the infrared laser line into a visible laser line;
a first non-linear optical fiber for generating an infrared frequency comb comprising a set of discrete infrared laser lines through a non-linear optical process; and
a second non-linear optical fiber for converting the infrared frequency comb into the visible frequency comb.

20. The device of claim 19, wherein the first non-linear optical fiber is disposed between the laser source and the wavelength converter along a propagation path of the infrared laser line; and wherein the second non-linear optical fiber is disposed after the wavelength converter along a propagation path of the infrared laser line.

21. The device of claim 19, wherein the first and the second non-linear optical fibers are the same portion of a non-linear optical fiber that is disposed after the wavelength converter.

22. The device of claim 19, wherein the wavelength converter comprises a frequency-doubling crystal.

23. The device of claim 19, wherein the laser source comprises:
a laser pump for producing a laser line;
a resonator comprising first and second Bragg lattices; and
a non-linear optical fiber in which the first and second Bragg lattices are formed.

24. A display system, comprising:
a light source for providing non-visible light;
a converter for converting the non-visible light into a visible light;
a light valve for modulating the converted visible light; and
a projection optics for projecting light from the spatial light modulator onto a display target.

25. The system of claim 24, wherein the converter comprises a non-liner optical element.
